(19) United States
(12) Patent Application Publication
(10) Pub. No.: US 2007/0143510 A1
(43) Pub. Date: Jun. 21, 2007

(54) COMMUNICATION STRUCTURE

(76) Inventor: Stephan Schultze, Lohr (DE)

Correspondence Address: MICHAEL J. STRIKER, 103 EAST NECK ROAD, HUNTINGTON, NY, 11743, US

(21) Appl. No.: 11/612,990

(22) Filed: Dec. 19, 2006

(30) Foreign Application Priority Data
Dec. 21, 2005 (DE) 10 2005 061 155.9

(51) Int. Cl. G06F 13/00

(52) U.S. Cl. 710/100

(57) ABSTRACT

A communication structure has a communication controller which has a synchronization unit and a first interface and a second interface, I/O connection means including a first I/O connection which for data exchange connects the first interface to a communication system having at least one further user, and a second I/O connection which connects the second interface to the communication system which has at least one further user, wherein the first interface and the second interface of the communication controller have a variable functionality.

### CROSS-REFERENCE TO A RELATED APPLIACTION

The invention described and claimed hereinbelow is also described in German Patent Application DE 10 2005 061 155.9 filed on Dec. 21, 2005. This German Patent Application, whose subject matter is incorporated here by reference, provides the basis for a claim of priority of invention under 35 U.S.C. 119(a)-(d).

### BACKGROUND OF THE INVENTION

The present invention generally relates to a communication structure and to a method for operating a communication structure.

More particularly it relates to a communication structure comprising a communication controller which has a synchronization unit and an interface 1 and a second interface 2, wherein, for the purpose of data exchange, interface 1 is connected by means of a first I/O connection and interface 2 is connected by means of a second I/O connection to a communication system which has at least one further user.

The invention also relates to a method for operating a communication structure comprising a communication controller which has a synchronization unit and a first interface and a second interface, wherein, for the purpose of data exchange, the first interface is connected by means of a first I/O connection and a second interface is connected by means of a second I/O connection to a communication system which has at least one further user.

Such communication structures are generally known. Distributed communication systems, in particular, can be encountered in many technical applications.

Thus, distributed communication systems are used, for example, in automation systems with decentralized control and drive technology in which a multiplicity of individual systems are often controlled and driven synchronously in time. Such an individual system can be a drive unit, for example comprising a synchronous or asynchronous motor by means of which one of a number of mutually interpolating axles or axles which are operating closely coupled to one another is driven. Typical fields of application of such automation systems with decentralized control and drive technology are printing machines or machine tools or robotic systems with a multiplicity of conveying and active elements operating synchronously with one another.

Typical communication systems comprise at least two, but as a rule far more users which are preferably arranged hierarchically with one user arranged as central user and the remaining users as other users of the communication system. Such an hierarchical structure of arrangement is known, for example, as master-slave structure with the central part or main user as “master” and the other users as “slave” (substation).

The central user is arranged as a central user who generates and sends control signals to the other users. The other users are communicatively connected for receiving these control signals and for further communication with the central user and usually also with the other further users as needed.

The slave users are in most cases related to connected process elements such as, e.g. sensors and actuators, i.e. input/output assemblies for analog and digital signals, and drive systems.

Furthermore, from the prior art, distributed communication systems are also known in which the master function can alternate between a number of users or even between all users. Such “multimaster” systems require that a number of users have the functionality of a central user and also exercise this function when a defined condition is present. In this arrangement, a user previously acting as further user becomes central user and the previous central user becomes further user of the communication system. A possible condition for such a change can be, for example, the lack of a control signal of the previous central user.

The network topologies depend on the requirements of the facilities to be networked together. The most frequent ones are star, line, tree and ring structures. In practice, a communication structure frequently consists of a mixed form of the structures mentioned above.

The characterizing feature of a star structure is a central switch with individual connections to all users of the communication structure. Applications for star-shaped network structures are areas with a high equipment density with small longitudinal extents, e.g. small production cells or a single production machine.

Tree topologies arise from the interlinking of a number of star structures to form one network. They are used in arranging complex installations into part-installations.

A line structure can be implemented by a switch which is located close to the user to be connected or by a switch which is integrated in the user. The line structure is preferably applied in installations with extensive structures, for example in conveyor systems and for linking production cells.

In a ring topology, the ends of a line are closed by an additional connection. Ring topologies are used in installations with increased requirements for availability for protecting against a line break or failure of a user.

In current communication control, only established protocols can be processed on a medium, as a rule (e.g. PROFIBUS protocol on an RS485 bus or DeviceNet on an RS485 bus). In multiprotocol modules, for example PROFIBUS master or PROFIBUS slave functions can also be covered. If, however, the communication protocols become very complex, variable programming with one module is very difficult. It is especially in the case of Ethernet-based protocols with very high communication speeds that software variability cannot be implemented or only with difficulty.

From DE 19917354 A1, different communication structures are known. The document relates to a synchronization method for a main unit and at least one secondary unit with internal timers, to be synchronized with one another, within a communication structure, particularly an annular communication structure with oppositely directed communication paths, wherein the main unit conveys to the secondary unit time signals over two communication paths which, as a rule, require different propagation times T1 and T2, respectively, to the secondary unit on the two communication paths. In this arrangement, the difference dT of the propagation times T1 and T2 is detected at least in the secondary unit and from the difference dT, the propagation times T1, T2 are determined, the timers becoming synchronized, taking into consideration the propagation times T1, T2, after the propagation times T1, T2 have been determined.

The variants of the communication structure illustrated in the abovementioned document are in each case arranged rigidly. Changing from one topology into another one is only effected by corresponding hardware adaptation.

### SUMMARY OF THE INVENTION

Accordingly, it is an object of the present invention to provide a communication structure and a method of operating such a communication structure which is a further improvement of the existing solutions.

More particularly, it is the object of the invention to provide a communication structure which allows a flexible communication topology and additionally provides for a reduction in hardware variants. It is also the object of the invention to provide a method for operating such a communication structure.

The object is achieved by the fact that the first interface and the second interface of the communication controller have a variable functionality which, on the one hand, provides for a reduction of hardware variants which contributes to lower costs with regard to production expenditure, storage, stock keeping of spare parts and, on the other hand, provides for high flexibility with regard to different communication topologies. Without any mechanical change, the hardware can include different functionalities, depending on parameterization, and can thus be used in different control environments or control topologies.

Having regard to the use in different topologies, it is advantageous if the first interface and the second interface of the communication controller are alterable with regard to correction values for a delay compensation in communication systems with delay during the initialization of the communication.

This is of advantage, in particular, if different communication topologies can be implemented with the first interface and the second interface of the communication controller.

If different communication protocols can be processed with the first interface and the second interface of the communication controller, different network systems can be connected.

In particular, a universal flexibility is achieved if the first interface and a second interface of the communication controller contain at least two different synchronization topologies.

If the synchronization topologies comprise the topologies master/master, master/slave, slave/slave, master/unsynchronized, slave/unsynchronized or unsynchronized/unsynchronized, different effective directions of synchronization can be implemented.

In this arrangement, a master interface, for example, represents a higher hierarchy of a control link-up. The slave interface, in contrast, can be coupled to a higher hierarchy level. In at least one unsynchronized interface, analog applications can also be connected, for example.

It is particularly advantageous if the communication system is based at least partially on Ethernet as a result of which comparatively high communication speeds can be achieved with software variability.

If the communication system is at least partially a real-time communication system, flexible communication controls for fast and precise machine controls can be implemented with correspondingly fast and precise synchronization methods.

The object relating to the method is achieved in that the first interface and the second interface of the communication controller are operated in different functions. This is advantageous with regard to the tying-in of different users with communication system links, for example field bus, master or slaves.

A preferred variant of the method provides that the first interface and the second interface of the communication controller are altered with regard to correction values for a delay compensation in communication systems with delay during the initialization of the communication. This makes it possible to take into consideration different signal delays which, in particular, is advantageous in branched communication systems with different users.

A further variant of the method provides that different communication protocols are processed with the first interface and the second interface of the communication controller. As a result, different users who communicate with different communication protocols can be tied into a common communication system.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

In the text which follows, the invention will be explained in greater detail with reference to an illustrative embodiment shown in the figures, in which:

FIG. 1 diagrammatically shows the basis of a communication structure,

FIG. 2 diagrammatically shows a communication structure as dual ring,

FIG. 3 diagrammatically shows a communication structure as two-line structure,

FIG. 4 diagrammatically shows a communication structure as two-line structure in master/master arrangement,

FIG. 5 diagrammatically shows a communication structure as two-line structure in master/slave arrangement,

FIG. 6 diagrammatically shows a communication structure as two-line structure in slave/slave arrangement.

### DESCRITION OF THE PREFERRED EMBODIMENTS

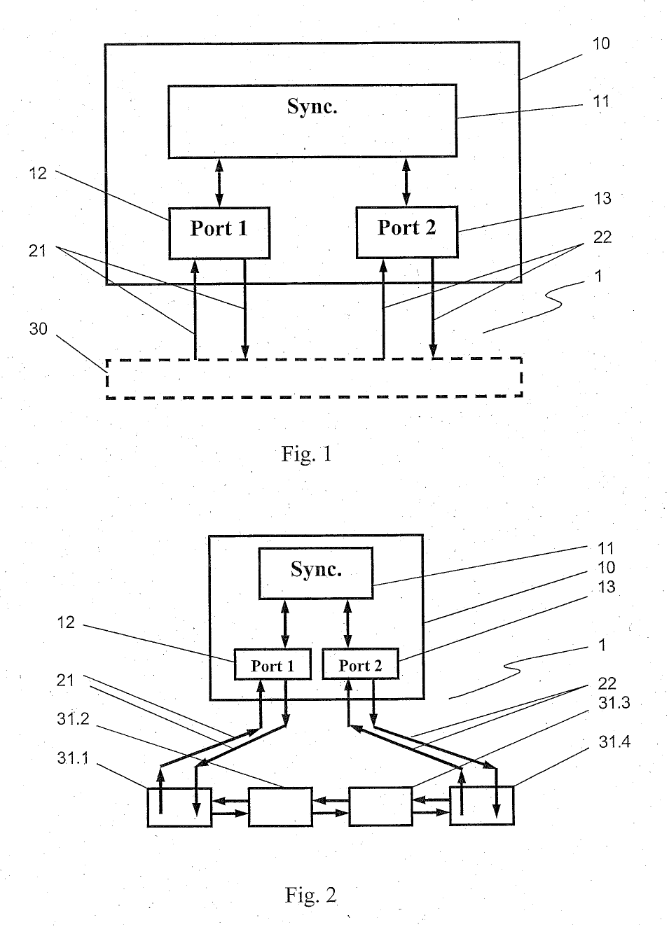

FIG. 1 diagrammatically shows the basis of a communication structure 1 which has a communication controller 10 as main unit and a communication system 30 which can have a different structure and consists of a number of users 31.1, 31.2, 31.3, 31.4 not shown explicitly here. In the example shown, the communication controller 10 has as an integral component a synchronization unit 11 (sync.) which provides for internal data exchange to a first interface 12 (port 1) and a second interface 13 (port 2).

The communication system 30 is connected to the communication controller 10 via a data exchange 20, the first interface 12 of the communication controller 10 being connected via a first I/O connection 21, and the second interface 13 being connected via a second I/O connection 22, to the communication system 30. In this arrangement, the various communication paths can be optical waveguides and/or arranged as wire connection, e.g. as profibus or Ethernet connection.

According to the invention, the interface 12 and the interface 13 of the communication controller 10 have variable functionality wherein correction values for the delay compensation can be altered with regard to a delay compensation in communication systems 30 with delay during the initialization of the communication. This variable functionality can be related to different field bus systems, i.e. communication protocols and to different effective synchronization directions. It is thus possible to implement different communication topologies and to process different communication protocols with the first interface 12 and with the second interface 13 of the communication controller 10.

In a preferred embodiment, the first interface 12 and the second interface 13 of the communication controller 10 contain at least two different synchronization topologies.

FIG. 2 shows a communication structure 1 which is arranged as redundant, oppositely directed dual ring wherein the two interfaces 12, 13 of the communication controller 10 form a closed dual ring with the users 31.1, 31.2, 31.3, 31.4 of the communication system 30. The data exchange 20 with the first interface 12 of the communication controller 10 is effected via a first I/O connection 21. The data exchange 20 with the second interface 13 is effected via a second I/O connection 22.

The oppositely directed runs of the communication structure 10 can be configured differently via the two interfaces 12, 13 of the communication controller 10 and possibly exchange different communication protocols. Such topologies are used in installations with increased requirements for availability for protecting against line break or failure of a user.

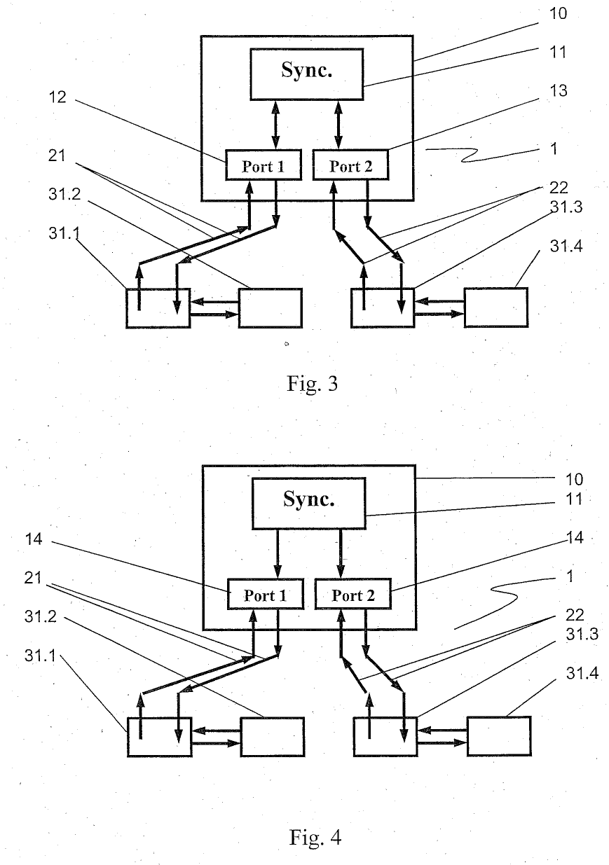

FIG. 3 shows a communication structure 1 which is arranged as 2-line structure. The two interfaces 12, 13 of the communication controller 10 form one communication each with the users 31.1, 31.2 and with the users 31.3, 31.4. Such line structures are preferably used in installations with extensive structures.

In the variant of the 2-line topology, different effective directions of the synchronization of the two lines are possible.

FIG. 4 diagrammatically shows by way of example a communication structure 1 as 2-line structure in master/master arrangement. The communication controller 10 has two mutually independent master interfaces 14 which are connected to the users 31.1, 31.2 and to the users 31.3, 31.4, respectively, in the form of a 2-line topology. Thus, for example, different control link-ups can be implemented.

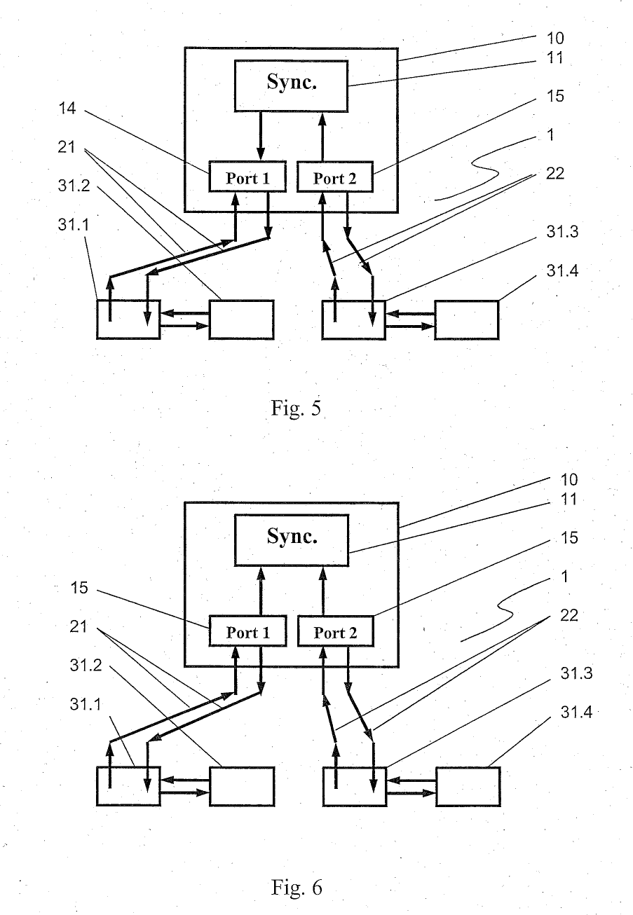

FIG. 5 diagrammatically shows a communication structure 1 as 2-line topology which, compared with the variant shown in FIG. 4, has a master interface 14 and a slave interface 15. The master interface 14 is connected to the users 31.1, 31.2 by means of the I/O connection 21 and the slave interface 15 is connected to the users 31.3, 31.4 by means of the I/O connection 22. In this arrangement, the master interface 14 represents a higher-level hierarchy of a control link-up. The slave interface 15, in contrast, is coupled to a higher hierarchy level.

The variant of a communication structure as 2-line topology, shown in FIG. 6, shows a communication controller 10 which has two mutually independent slave interfaces 15. The first slave interface 15 is connected to the users 31.1, 31.2 by means of the I/O connection 21 and the second slave interface 15 is connected to the users 31.3, 31.4. Both slave interfaces 15 are coupled to higher, possibly completely separate control hierarchies.

In embodiments not shown here, one or both interfaces 12, 13 of the communication controller 10 can also be arranged as unsynchronized interface which can also be analog in particular embodiments.

In further variants of the embodiment, the 2-line topology described above can serve different communication systems 30. Examples of these are PROFINET and SERCOS III or SERCOS III and an engineering interface, respectively. In further variants of the embodiment, the communication system 30 is based at least partially on Ethernet.

Using correspondingly fast and precise synchronization methods, a flexible communication controller 10 with mutually freely configurable interfaces 12, 13 or with one or two master interfaces 14 and/or with one or two slave interfaces 15, respectively, can also be used at least partially in a real-time communication system.

The communication structure 1 described and the special embodiment of the communication controller 10 and the method described provide, on the one hand, for a reduction of hardware variants which contributes to lower costs. On the other hand, high flexibility can be achieved with regard to different communication topologies.

It will be understood that each of the elements described above, or two or more together, may also find a useful application in other types of constructions differing from the types described above.

While the invention has been illustrated and described as embodied in a communication structure, in particular drilling screwdriver, it is not intended to be limited to the details shown, since various modifications and structural changes may be made without departing in any way from the spirit of the present invention.

Without further analysis, the foregoing will so fully reveal the gist of reveal present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims.

1. A communication structure, comprising a communication controller which has a synchronization unit and a first interface and a second interface; I/O connection means including a first I/O connection which for data exchange connects said first interface to a communication system having at least one further user, and a second I/O connection which connects said second interface to the communication system which has at least one further user, said first interface and said second interface of said communication controller having a variable functionality.

2. A communication structure as defined in claim 1, wherein said first interface and said second interface of said communication controller are configured so that they are alterable with regard to correction values for a delay compensation in the communication system with delay during an initialization of a communication.

3. A communication structure as defined in claim 1, wherein said first interface and said second interface of said communication controller are configured so that different communication topologies are implementable with said first interface and said second interface.

4. A communication structure as defined in claim 1, wherein said first interface and said second interface of said communication controller are configured so that different communication protocols are processable with said first interface and said second interface.

5. A communication structure as defined in claim 1, wherein said first interface and said second interface of said communication controller contain at least two different synchronization topologies.

6. A communication structure as defined in claim 5, wherein said synchronization topologies comprise topologies selected from the group consisting of master/master, master/slave, slave/slave, master/unsynchronized, slave/unsynchronized and unsynchronized/unsynchronized.

7. A communication structure as defined in claim 1, wherein said communication system is based at least partially on Ethernet.

8. A communication structure as defined in claim 1, wherein said communication system is at least partially a real-time communication system.

9. A method for operating a communicating structure, comprising the steps of providing a communication controller which has a synchronization unit and a first interface and a second interface; connecting for data exchange said first interface by a first I/O connection and said second interface by a second I/O connection to a communication system which has at least one further user; and operating said first interface and said second interface of said communication controller in different functions.

10. A method as defined in claim 9; and further comprising altering said first interface and said second interface of said communication controller with regard to correction values for a delay compensation in the communication system with delay during an initialization of a communication.

11. A method as defined in claim 9; and further comprising processing different communication protocols with said first interface and said second interface of said communication controller.
